(19) United States
(12) Patent Application Publication
(10) Pub. No.: US 2006/0026350 A1
(43) Pub. Date: Feb. 2, 2006

(54) Method and apparatus to automatically switch memory cards in a multi-functional device, and method of configuring a removable disc driver

(76) Inventors: Kyoung-jae Lee, Suwon-si (KR); Dong-hoon Lee, Incheon Metropolitan-City (KR)

Correspondence Address: STANZIONE & KIM, LLP, 919 18TH STREET, N.W., SUITE 440, WASHINGTON, DC, 20006, US

(21) Appl. No.: 11/189,844

(22) Filed: Jul. 27, 2005

(30) Foreign Application Priority Data
Jul. 28, 2004 (KR) 2004-59195
Sep. 23, 2004 (KR) 2004-76348

(51) Int. Cl. G06F 13/00

(52) U.S. Cl. 711/115

(57) ABSTRACT

A method of automatically switching among memory cards inserted into a plurality of memory card slots in an image forming apparatus, respectively includes determining memory card types and a number of the memory cards inserted into the plurality of memory card slots, determining whether switching of the memory cards is appropriate, automatically switching from a current memory card to a next memory card according to a predefined order, when it is determined that switching of the memory cards is appropriate, and exchanging data with the next memory card. A method of configuring removable disk drivers in a host device connected to a multi-memory card reader having a plurality of memory card slots includes determining whether memory cards are inserted into the plurality of memory card slots, respectively, counting a number of memory card slots having corresponding memory cards inserted therein, and transmitting a counted number of memory card slots having the corresponding memory cards inserted therein to the host device.

### CROSS-REFERENCE TO RELATED APPLICATIONS

This application claims priority from Korean Patent Application No. 2004-59195, filed on Jul. 28, 2004 and Korean Patent Application No. 2004-76348, filed on Sep. 23, 2004, in the Korean Intellectual Property Office, the disclosures of which are incorporated herein in their entirety by reference.

### BACKGROUND OF THE INVENTION

1. Field of the Invention

The present general inventive concept relates to a multifunctional apparatus, and more particularly, to a method and apparatus to automatically switch memory cards in a multifunctional device by controlling an order of the memory cards inserted into memory card slots and switching the memory cards according to the controlled order.

The present general inventive concept also relates to a method of configuring removable disc drivers for a multi-memory card reader, and a printer having the multi-memory card reader, and more particularly, to a method of configuring removable disk drivers of a multi-memory card reader, the number of removable disk drivers being equal to a number of memory card slots having memory cards are inserted thereon, and a printer having the multi-memory card reader.

2. Description of the Related Art

Multifunctional devices having a plurality of different functions include devices, such as a printer, a scanner, a copy machine, and a facsimile. The multifunctional devices have become popular due to a consumer demand for high performance and multiple functionality.

The multifunctional device or a printer (e.g., a photo printer) can support various memory card types. The memory card must be inserted into a memory card slot in the multifunctional device in order to output data (e.g., scan image data) that is stored in the memory card to the multifunctional device

In order to support various memory card types, a conventional multifunctional device includes a plurality of memory card slots into which a memory card is to be inserted. Nonetheless, it is difficult to access a plurality of memory cards that are inserted into the plurality of memory card slots.

For instance, the conventional multifunctional device does not permit two or more memory cards to be simultaneously inserted into respective memory card slots. In other words, when a first memory card is inserted into a first memory card slot of the conventional multifunctional device while a second memory card is inserted into a second memory card slot thereof, the conventional multifunctional device typically generates a warning message that the memory card that was first inserted (i.e., the first memory card) or newly inserted (i.e., the second memory card) must be removed from the respective memory card slot. Specifications of the conventional multifunctional device determine whether the first memory card or the second memory card should be removed. Thus, in order to use a new memory card in the conventional multifunctional device, the new memory card must be inserted only after a memory card that is presently inserted is removed from the memory card slot. This causes a user inconvenience. Further, a memory card is likely to be damaged, since the memory card must frequently be inserted and/or removed from the respective memory card slot.

Another type of conventional multifunctional device permits two or more memory cards to be simultaneously inserted into memory card slots. However, in this case, only one of the inserted memory cards can be used at a given time. Accordingly, it is difficult to switch memory cards in the conventional multifunctional device.

U.S. Patent Application Publication No. 2000-0044295 discloses a printing apparatus in which a plurality of memory card slots are formed and a memory card selection key is pressed to select a memory card to be used. Thus, a user is required to press the memory card selection key in order to switch from a memory card that is currently being used to another memory card.

There are various memory card types including, for example, a compact flash (CF) card, a secure digital (SD) card, a smart media (SM) card, and a memory stick (MS). These memory card types are different from one another in size and shape, thus memory card slots are typically formed to correspond to the respective memory card types.

A conventional multi-memory card reader that includes a plurality of memory card slots corresponding to the various memory card types has been developed. In general, the conventional multi-memory card reader is connected to a host device to transmit information stored in a selected memory card, receive data from the host device, and store the data in the selected memory card. Typically, when the conventional multi-memory card reader is connected to the host device, removable disk drivers that correspond to the memory card slots are created in the host device.

FIG. 1 illustrates four removable disk drivers 102, 104, 106, and 108 installed in the conventional multi-memory card reader. As illustrated in FIG. 1, when the conventional multi-memory card reader includes four memory card slots, four removable disk drivers 102, 104, 106, and 108 that correspond to the four memory card slots are created in the host device.

In order to use the conventional multi-memory card reader, a user inserts a memory card into a corresponding memory card slot in the conventional multi-memory card reader. The conventional multi-memory card reader is then connected to the host device via a Universal Serial Bus (USB) cable.

Next, a device driver of the conventional multi-memory card reader is driven and the removable disk drivers 102, 104, 106, and 108 that correspond to the memory card slots in the conventional multi-memory card reader are generated in the host device. The user can then use the removable disk drivers 102, 104, 106, and 108 using an application program such as a window explorer.

As described above, removable disk drivers are generated to correspond to all memory card slots in the conventional multi-memory card reader. In other words, a removable disk driver that corresponds to a memory card slot into which a memory card is not inserted is also generated. Thus, since the removable disk drivers are generated for every memory card slot, regardless of whether the memory card slot is actually being used (i.e., has a corresponding memory card slot inserted therein), it is difficult for the user to determine which of the removable disk drivers corresponds to a memory card slot into which a memory card is inserted. This causes the user confusion.

### SUMMARY OF THE INVENTION

The present general inventive concept provides a method of automatically switching memory cards in a multifunctional device by controlling an order of the memory cards that are inserted into corresponding memory card slots in the multifunctional device and automatically switching the memory cards according to the controlled order.

The present general inventive concept also provides an apparatus to automatically switch memory cards in a multifunctional device by controlling an order of memory cards that are inserted into corresponding memory card slots in the multifunctional device and automatically switching the memory cards according to the controlled order.

The present general inventive concept also provides a method of generating removable disk drivers that correspond to memory card slots of a multi-memory card reader having corresponding memory cards inserted therein.

The present general inventive concept also provides a printer that includes a multi-memory card reader to generate removable disk drivers that correspond to memory card slots having corresponding memory cards inserted therein.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a method of automatically switching among memory cards inserted into a plurality of memory card slots in an image forming apparatus, respectively, the method comprising determining memory card types and a number of the memory cards inserted into the plurality of memory card slots, determining whether switching of the memory cards is appropriate, automatically switching from a current memory card to a next memory card according to a predefined order when it is determined that switching of the memory cards is appropriate, and exchanging data with the next memory card. The image forming apparatus can comprise a multifunctional device or a printer.

The foregoing and/or other aspects of the present general inventive concept are also achieved by providing an apparatus to automatically switch among memory cards inserted into a plurality of memory card slots in an image forming apparatus, respectively, the apparatus comprising a memory card history manager to manage histories of the memory cards inserted into the plurality of memory card slots, a controller to automatically switch from a current memory card to a next memory card according to a predefined order when switching of the memory cards is appropriate, and a memory card interface unit to enable data to be exchanged with the next memory card.

The foregoing and/or other aspects of the present general inventive concept are also achieved by providing a method of configuring removable disk drivers in a host device connected to a multi-memory card reader associated with a plurality of memory card slots, the method comprising determining whether memory cards are inserted into the plurality of memory card slots, respectively, counting a number of memory card slots having corresponding memory cards inserted therein, and transmitting the counted number of memory card slots having the corresponding memory cards inserted therein to the host device.

The foregoing and/or other aspects of the present general inventive concept are also achieved by providing a printer in communication with a host device, the printer comprising a multi-memory card reader having a plurality of memory card slots, a determining unit to determine whether memory cards are inserted into the plurality of memory card slots, respectively, a counting unit to count a number of memory card slots having the corresponding memory cards inserted therein, and a transmitting unit to transmit the counted number of memory card slots to the host device.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates removable disk drivers for a conventional multi-memory card reader;

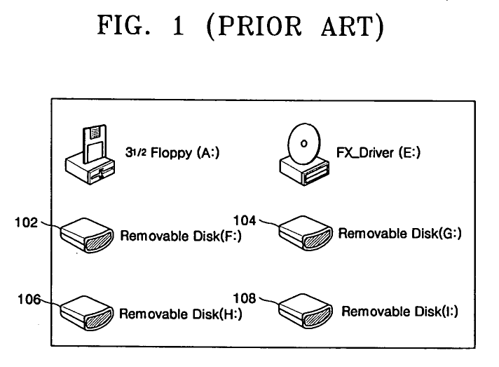

FIG. 2 is a block diagram illustrating a multifunctional device that includes an apparatus to automatically switch memory cards according to an embodiment of the present general inventive concept;

FIG. 3 is a flowchart illustrating a method of automatically switching memory cards according to an embodiment of the present general inventive concept;

FIG. 4 is a flowchart illustrating a method of managing a history of a memory card according to an embodiment of the present general inventive concept;

FIG. 5 illustrates a plurality of memory card slots;

FIG. 6A illustrates a file allocation table (FAT) of a plurality of memory cards in an automatic switching mode according to an embodiment of the present general inventive concept;

FIG. 6B illustrates an FAT of a plurality of memory cards in a passive switching mode according to an embodiment of the present general inventive concept;

FIG. 7 is a block diagram illustrating a multi-memory card reader and a host device according to an embodiment of the present general inventive concept;

FIG. 8 is a block diagram illustrating a printer having a multi-memory card reader connected to a host device according to an embodiment of the present general inventive concept; and

FIG. 9 is a flowchart illustrating a method of configuring removable disk drivers using a multi-memory card reader according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

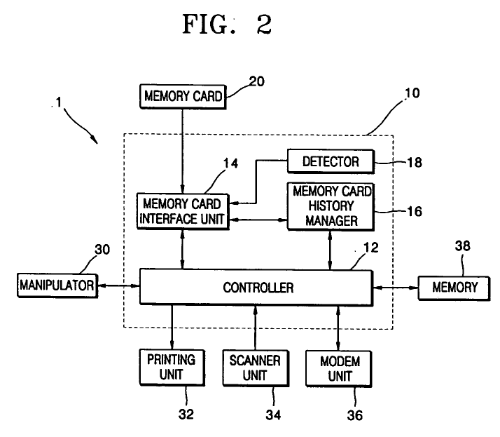

FIG. 2 is a block diagram illustrating a multifunctional device 1 including an apparatus 10 to automatically switch memory cards according to an embodiment of the present general inventive concept. Referring to FIG. 2, the multifunctional device 1 may further include a manipulator 30, a printing unit 32, a scanner unit 34, a modem unit 36, and a memory 38. These components perform general functions of the multifunctional device 1.

Although not shown in the drawings, the manipulator 30 may include keys to set or change operation modes and/or switching modes of the multifunctional device 1, and a display unit to display the operation and/or switching modes of the multifunctional device 1.

The printing unit 32 is used to print data received from a memory card 20, data received from a computer (not shown) that is connected to the multifunctional device 1, or data stored in the memory 38. The scanner unit 34 converts analog image data transmitted from an image sensor (not shown) into digital image data and transmits the digital image data to the memory 38 or the memory card 20. The modem unit 36 enables data to be exchanged between a controller 12 and an external data transmission device, such as a facsimile (not shown).

The memory 38 stores a program that operates the controller 12, a general control program, and data that is processed by the controller 12 when the program is running. Additionally, the memory 38 stores data to be printed or scanned data.

The automatic memory card switching apparatus 10 includes the controller 12, a memory card interface unit 14, a memory card history manager 16, and a detector 18.

The multifunctional device 1 includes a plurality of memory card slots (not shown).

The memory card history manager 16 manages histories of memory cards that are inserted into the memory card slots, respectively. Additionally, the memory card history manager 16 can determine an order in which the memory cards are to be switched (i.e., a switching order) according to an order in which the memory cards are inserted into the plurality of memory slots (i.e., an insertion order). Alternatively, the memory card history manager 16 can determine the switching order according to a predetermined order that is independent of the insertion order. When the multifunctional device 1 is turned on, the memory card history manager 16 can rearrange the switching order of the memory cards according to a frequency with which the memory cards are used. For example, the switching order of the memory cards can be arranged from most frequently used to least frequently used.

The controller 12 determines whether a switching mode of the multifunctional device 1 is set to an automatic switching mode. When the switching mode of the multifunctional device 1 is set to the automatic switching mode, the controller 12 determines whether switching of the memory cards is appropriate. When the controller 12 determines that the switching of the memory cards is appropriate, the controller 12 automatically switches from a memory card that is currently used to a next memory card according to the switching order specified by the histories of the memory cards that are inserted into the memory card slots. When the switching mode is not set to the automatic switching mode, the controller 12 allows a user to select a desired memory card from among the memory cards that are inserted into the memory card slots via a user interface unit (e.g., the manipulator 30), which is installed in the multifunctional device 1. In this case, only the selected memory card is accessible without switching the memory cards.

The memory card interface unit 14 enables an exchange of data between the selected memory card and the controller 12. Additionally, the memory card interface unit 14 may create a file allocation table (FAT) that shows and/or displays a file order in which files are stored in the selected memory card. For instance, the controller 12 can determine whether switching of the memory cards is appropriate when a user moves an indicator (not shown) on a first file or a last file in a first FAT to point to a file in a second FAT using the user interface unit (e.g., the manipulator 30) that is installed in the multifunctional device 1.

The memory card interface unit 14 may read data stored in the selected memory card to determine a memory card type of the selected memory card and to set a method of controlling the selected memory card according to the determined memory card type. The memory card interface 14 may also read the data stored in the selected memory card and recreate the corresponding FAT to show the file order in which files are stored in the selected memory card.

The detector 18 allocates an input/output (I/O) port to each of the memory card slots to determine whether a memory card is inserted into or is removed from each of the memory card slots.

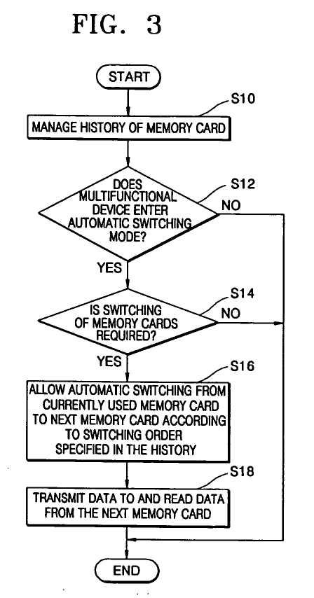

FIG. 3 is a flowchart illustrating a method of automatically switching memory cards according to an embodiment of the present general inventive concept. Referring to FIG. 3, histories of memory cards that are inserted into a plurality of memory card slots in a multifunctional device are managed (operation S10). In the operation S10, an order in which the memory cards are to be switched (i.e., a switching order) may be determined according to an order in which the memory cards are inserted into their corresponding memory card slots (i.e., an insertion order). Alternatively, the switching order may correspond to a predetermined order that is independent from the insertion order.

It is then determined whether a switching mode of the multifunctional device is set to an automatic switching mode (operation S12). If it is determined in the operation S12 that the switching mode is not set to the automatic switching mode, the method of FIG. 3 is complete. When the switching mode is determined to be set to the automatic switching mode, it is determined whether switching of the memory cards is appropriate (i.e., is required) (operation S14).

An FAT showing a file order in which files are stored in a currently selected memory card may be created. When a user moves an indicator on a first file or a last file in a first FAT to point to a file in a second FAT in the operation S14, it may be determined that the switching of the memory cards is appropriate.

When it is determined in the operation S14 that switching is not appropriate, the method of FIG. 3 is complete. When switching is determined to be appropriate in the operation S14, automatic switching from a memory card that is currently used to a next memory card is performed according to the switching order specified by the histories of the memory cards (operation S16). The next memory card may be initialized.

Data is then exchanged between the next memory card and a controller (operation S18). For instance, the controller can read data stored in the next memory card to determine a memory card type of the next memory card. The controller can then set a method of controlling the next memory card according to the determined memory card type. The data stored in the next memory card may be displayed such that a user can view the data. In this case, the user can receive the memory card type of the next memory card. The FAT that shows the file order in which files are stored in the next memory card may be recreated using the data stored in the next memory card. Additionally, the data stored in the next memory card may be stored in a memory of the multifunctional device, printed, or transmitted to a computer connected to the multifunctional device.

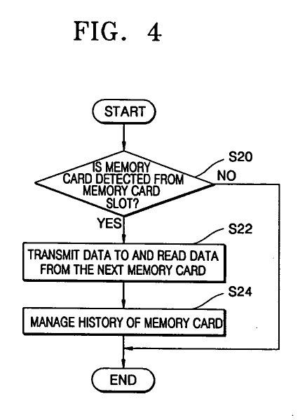

FIG. 4 is a flowchart illustrating a method of managing a history of a memory card according to an embodiment of the present general inventive concept. Referring to FIG. 4, it is determined whether a memory card is inserted into one of a plurality of memory card slots (operation S20). An I/O port that detects a memory card may be allocated to the plurality of memory card slots, respectively, to perform the determination of the operation S20. The I/O port may be checked periodically (e.g., every second) to detect memory cards that are inserted into the memory card slots. Alternatively, an interrupt may be generated to detect the memory cards that are inserted into the memory card slots.

If it is determined in the operation S20 that a memory card is not inserted into the memory card slot, the method of FIG. 4 is complete. If it is determined in the operation S20 that a memory card is inserted into the memory card slot, data is transmitted to and/or is read from the memory card that is inserted in the memory card slot (operation S22). A memory card type of the memory card that is inserted in the memory card slot can be determined using data that is read from the memory card.

The history of the detected memory card is then managed (operation S24). For instance, the history of the memory card can be included in a memory card history file by a memory card history manager. Histories of other memory cards that are inserted into other memory card slots can also be included in the memory card history file.

For instance, an order in which the memory cards are to be switched (i.e., a switching order) is specified by the histories of the memory cards. When switching of the memory cards is appropriate, the switching may be performed according to the switching order. The switching order may correspond to an order in which the memory cards are inserted into the plurality of memory card slots (i.e., an insertion order), respectively, or may correspond to a predetermined order that is independent of the insertion order.

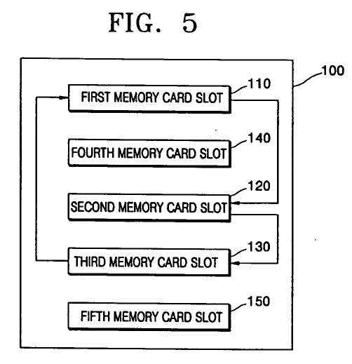

FIG. 5 illustrates a memory card slot unit 100 according to an embodiment of the present general inventive concept. The memory card slot unit 100 includes a first memory card slot 110, a second memory card slot 120, a third memory card slot 130, a fourth memory card slot 140, and a fifth memory card slot 150. First, second, and third memory cards are inserted into the first, second, and third memory card slots 110, 120, and 130, respectively, and no memory cards are inserted into the fourth and fifth memory card slots 140 and 150.

Each of the first, second, and third memory cards may be one of a compact flash (CF) card, a secure digital (SD) card, a smart media (SM) card, and a memory stick (MS). Other memory card types may also be used with the embodiments of the present general inventive concept. The first, second, third, fourth, and fifth memory card slots 110, 120, 130, 140, and 150 can correspond to various memory card types.

According to an embodiment of the present general inventive concept, histories of the first, second, and third memory cards that are inserted into the first, second, and third memory card slots 110, 120, and 130, respectively, are managed. It can be assumed that a switching order includes the first memory card, the second memory card, and the third memory card, respectively, and that the first memory card is switched to the second memory card, and then to the third memory card. In this case, according to the present general inventive concept, it is possible to automatically switch from the first memory card to the second memory card, or vice versa.

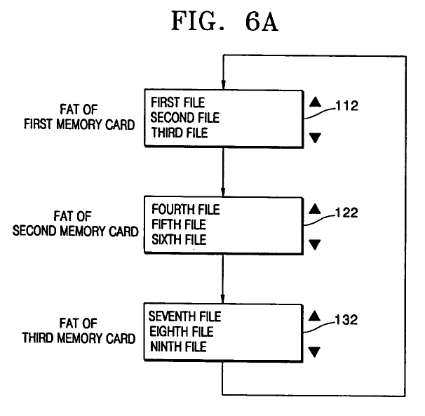

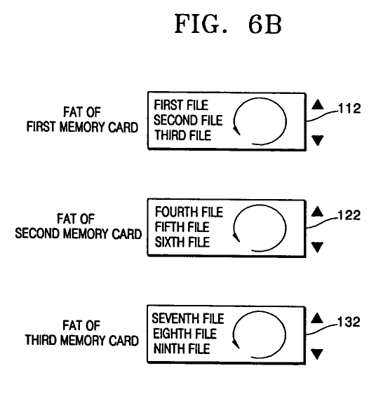

A method of automatically switching memory cards in an automatic switching mode according to an embodiment of the present general inventive concept will now be described with reference to FIG. 6A. FIG. 6A illustrates first, second, and third file allocation tables (FATs) 112, 122, and 132 that correspond to first, second, and third memory cards (not shown), respectively, in the automatic switching mode.

Referring to FIG. 6A, first, second, and third files are included in the first FAT 112; fourth, fifth, and sixth files are included in the second FAT 122; and seventh, eighth, and ninth files are included in the third FAT 132. When a user moves an indicator on the third file of the first FAT 112 to point to the fourth file of the second FAT 122 by pressing a downward arrow key of a multifunctional device, an automatic switching from the first memory card to the second memory card can be performed. In this case, the second FAT 122 of the second memory card is recreated. In general, files are arranged in an FAT in alphabetical order or in a file order in which the files are generated. The user may also arbitrarily determine the order in which the files are to be arranged in the FAT. When the indicator is on the fourth file of the second FAT 122 and the user presses an upward arrow key of the multifunctional device, switching from the second memory card to the first memory card is automatically performed. In this case, the first FAT 112 is recreated and the third file of the first FAT 112 is selected.

Referring to FIG. 6A, when the indicator is on the ninth file of the third FAT 132 and the downward arrow key is pressed to select the first file of the first FAT 112, switching from the third memory card to the first memory card is automatically performed.

If the user desires to use a single memory card, a passive switching mode can be selected as a switching mode of the multifunctional device. FIG. 6B illustrates first, second, and third FATs 112, 122, and 132 that correspond to first, second, and third memory cards, respectively, in the passive switching mode according to an embodiment of the present general inventive concept.

As illustrated in FIG. 6B, a user can select and use a single memory card. Referring to FIG. 6B, when an indicator is on a third file of the first FAT 112, a user presses a downward arrow key to select a first file of the first FAT 112. In this case, switching from the first memory card to the second memory card is not performed. This is also applied to the second and third FATs 122 and 132. That is, movement of the indicator is permitted within a single FAT 112, 122, or 132. When the user desires to use another memory card, the user may easily select and use the desired memory card in the passive switching mode.

Although the embodiments of the present general inventive concept are described above with reference to a multifunctional device, the present general inventive concept is not limited to the above description. For instance, the embodiments of the present general inventive concept can be applied to a photo printer, a scanner, etc.

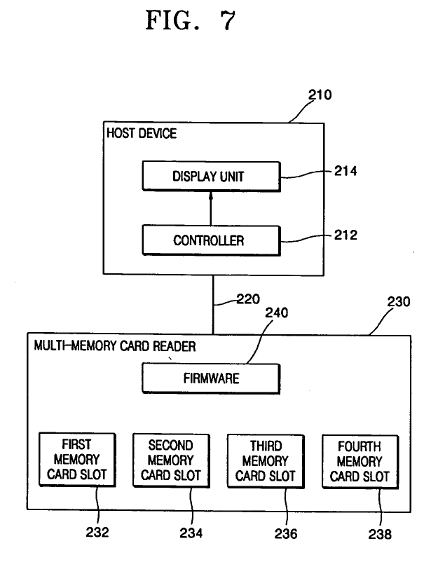

FIG. 7 is a block diagram illustrating a multi-memory card reader 230 and a host device 210 according to an embodiment of the present general inventive concept. The host device 210 includes a controller 212 and a display unit 214. The multi-memory card reader 230 includes first, second, third, and fourth memory card slots 232, 234, 236, and 238, and firmware 240.

Referring to FIG. 7, the multi-memory card reader 230 is connected to the host device 210 via an interface 220. The interface 220 may be a wireless interface or a cable interface, such as a universal serial bus (USB) cable. When the multi-memory card reader 230 is connected to the host device 210, the multi-memory card reader 230 transmits corresponding hardware information thereof to the host device 210.

The multi-memory card reader 230 determines whether a memory card is inserted into each of a plurality of memory card slots, and counts the memory card slots into which memory cards are inserted. The firmware 240 is configured in the multi-memory card reader 230, and enables the counted number of memory card slots to be recorded using a logical unit number (LUN), and can thereby update the LUN. The LUN is transmitted from the multi-memory card reader 230 to the host device 210.

The host device 210 drives a device driver installed in the multi-memory card reader 230 using the hardware information transmitted from the multi-memory card reader 230. The device driver requests the firmware 240 to provide the LUN to the host device 210. The firmware 240 then transmits the LUN to the host device 210 in response to the request.

The controller 212 of the host device 210 generates removable disk drivers using the LUN. The controller 212 generates the removable disk drivers that correspond to the first, second, third, and fourth memory card slots 232, 234, 236, and 238 into which the memory cards are inserted, respectively. The generated removable disk drivers are displayed on the display unit 214. A user may use data stored in the memory cards inserted into the corresponding first, second, third, and fourth memory card slots 232, 234, 236, and 238 using the displayed removable disk drivers.

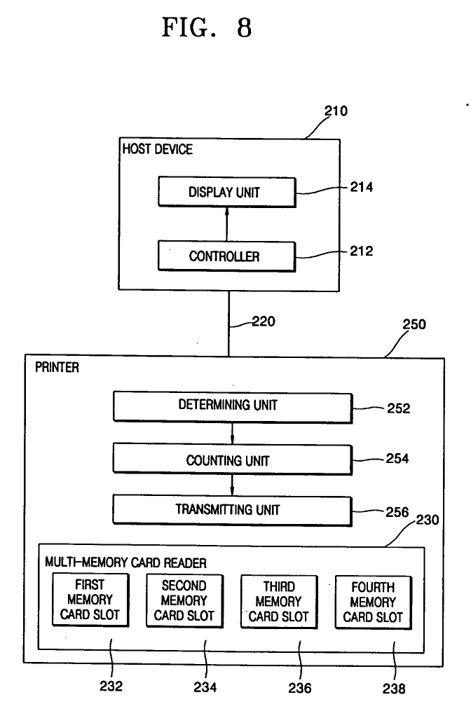

A printer having a multi-memory card reader according to the present general inventive concept will now be described with reference to FIG. 8. FIG. 8 is a block diagram illustrating a printer 250 having a multi-memory card reader 230 and a host device 210 according to an embodiment of the present general inventive concept. Similar elements in FIGS. 7 and 8 have similar reference numerals.

The host device 210 includes a controller 212 and a display unit 214. The printer 250 includes a determination unit 252 that determines whether memory cards are inserted into first, second, third, and fourth memory card slots 232, 234, 236, and 238, respectively; a counting unit 254 that counts memory cards inserted into the first, second, third, and fourth memory card slots 232, 234, 236, and 238; a transmitting unit 256 that transmits the counted number of the inserted memory cards to the host device 210; and the multi-memory card reader 230. The multi-memory card reader 230 includes the first, second, third, and fourth memory card slots 232, 234, 236, and 238.

Referring to FIG. 8, the printer 250 is connected to the host device 210 via an interface 220. The interface 220 may be a wireless interface or a cable interface, such as a USB cable. When the printer 250 is connected to the host device 210, the printer 250 transmits information regarding the hardware of the multi-memory card reader 230 to the host device 210.

The counting unit 254 may generate an LUN equivalent to the counted number of memory cards inserted into the first, second, third, and fourth memory card slots 232, 234, 236, and 238. In other words, the counting unit 254 updates the LUN by recording the counted number of the inserted memory cards using the LUN. The LUN is included with information transmitted from the printer 250 to the host device 210. The transmitting unit 256 transmits the LUN to the host device 210.

When the memory cards are removed from any of the first, second, third, and fourth memory card slots 232, 234, 236, and 238 or new memory cards are inserted into any of the first, second, third, and fourth memory card slots 232, 234, 236, and 238 in the multi-memory card reader 230, the counting unit 254 can recount the number of memory cards inserted in the into the first, second, third, and fourth memory card slots 232, 234, 236, and 238.

The controller 212 of the host device 210 generates removable disk drivers using the LUN received from the printer 250. That is, the controller 212 generates the removable disk drivers to correspond to the memory cards inserted into the first, second, third, and fourth memory card slots 232, 234, 236, and 238. The controller 212 does not, however, generate a removable disk driver for memory card slots that do not have corresponding memory cards inserted therein. The generated removable disk drivers are then displayed on the display unit 214. A user may use data stored in the inserted memory cards using the displayed removable disk drivers.

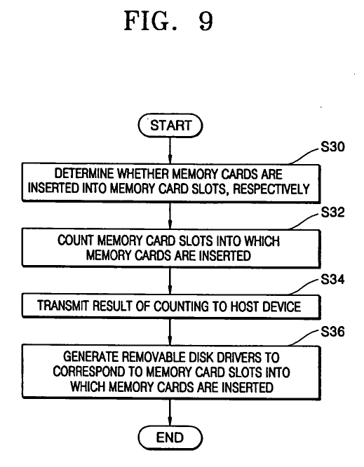

FIG. 9 is a flowchart illustrating a method of creating removable disk drivers using a multi-memory card reader according to an embodiment of the present general inventive concept. With reference to FIG. 9, a method of creating the removable disk drivers in a host device connected to the multi-memory card reader having a plurality of memory card slots. Referring to FIG. 9, it is determined whether memory cards are inserted into corresponding memory card slots (operation S30). The number of the memory card slots into which the memory cards are inserted is then counted (operation S32). The counted number is then transmitted to the host device (operation S34), and removable disk drivers are generated to correspond to the inserted memory cards in the host device (operation S36).

When any of the memory cards are removed or new memory cards are inserted into the memory card slots, respectively, the memory cards may be counted again and a new counted number of memory cards that are inserted into the memory card slots is provided to the host device.

An LUN that corresponds to the counted number of the inserted memory cards may be generated in the operation S32, and the LUN may be transmitted to the host device in the operation S34. The LUN is included with information transmitted from the multi-memory card reader to the host device. In other words, the counted number of the inserted memory cards may be recorded using the LUN and the LUN may be transmitted to the host device.

Additionally, the method of FIG. 9 may further include displaying the generated removable disk drivers such that a user can view them.

Although the embodiments of the present general inventive concept are described above with respect to a multi-memory card reader having a plurality of memory card slots, and a printer that includes the multi-memory card reader, the various embodiments of the present general inventive concept are not limited to the above description. For instance, the various embodiments of the present general inventive concept can be applied to a multifunctional device or an image forming apparatus that includes a multi-memory card reader having a plurality of memory card slots. The multifunctional device may include at least one of the functions of a printer, a scanner, a copy machine, and a facsimile.

As described above, according to the embodiments of the present general inventive concept, it is possible to control a switching order in which memory cards inserted into memory card slots in a multifunctional device are automatically switched.

Since various memory card types can be simultaneously inserted into respective memory card slots, it is not required to remove a memory card that is currently used from a respective memory card slot in order to use another memory card. Therefore, it is possible to prevent the memory card from being damaged, which can be caused by frequently inserting the memory card into or removing the memory card from the respective memory card slot.

When the multifunctional device enters a passive switching mode, a user may select and use a desired memory card.

Additionally, data read from a memory card allows the user to determine the type of a memory card that is currently being used.

According to the present general inventive concept, it is possible to maximize use of a memory card and store memory cards in corresponding memory card slots.

The embodiments of the present general inventive concept can be embodied in software, hardware, or a combination thereof. In particular, some embodiments can be computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, DVDs, etc.), and storage media such as carrier waves (e.g., transmission through the internet). The computer readable recording medium can also be distributed over network coupled computer systems so that the computer programs are stored and executed in a distributed fashion.

Additionally, according to the various embodiments of the present general inventive concept, removable disk drivers are generated to correspond to memory card slots into which memory cards are inserted, and are displayed such that a user can view them. Since only removable disk drivers corresponding to memory card slots into which memory cards are inserted are displayed (i.e., only available removable disk drivers are displayed), it is possible to increase convenience of the user when accessing the removable disk drivers. That is, it is possible to avoid confusion caused by accessing a removable disk driver that corresponds to a memory card slot into which a memory card is not inserted, since the removable disk driver is not generated and displayed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of automatically switching among memory cards inserted into a plurality of memory card slots in a multifunctional device, respectively, the method comprising:
determining memory card types and a number of the memory cards inserted into the plurality of memory card slots;
determining whether switching of the memory cards is appropriate;
automatically switching from a current memory card to a next memory card according to a predefined order, when it is determined that switching of the memory cards is appropriate; and
exchanging data with the next memory card.

2. The method of claim 1, wherein the predefined order comprises a switching order that is defined by one of an insertion order in which the memory cards are inserted into the plurality of memory card slots and a predetermined order that is independent of the insertion order.

3. The method of claim 1, wherein the automatic switching from the current memory card to the next memory card comprises creating a file allocation table to display a file order in which files are stored in the current memory card.

4. The method of claim 3, wherein the determining of whether the switching of the memory cards is appropriate comprises determining that switching of the memory cards is appropriate when a user moves an indicator on a first file or a last file of the file allocation table to point to a file in another file allocation table.

5. The method of claim 1, wherein the exchanging of data with the next memory card comprises receiving data about the next memory card from the next memory card.

6. The method of claim 1, further comprising:
displaying a graphical representation of the switching from the current memory card to the next memory card in a display unit of the multifunctional device.

7. The method of claim 1, further comprising:
determining whether a switching mode of the multifunctional device is set to an automatic switching mode.

8. The method of claim 1, further comprising:
printing data stored in the next memory card by switching between the current and the next memory cards.

9. A method of managing a plurality of memory card slots in an image forming apparatus, the method comprising:
determining which of the plurality of memory card slots have corresponding memory cards inserted therein; and
enabling automatic switching among the memory cards that are inserted in the corresponding memory card slots.

10. The method of claim 9, further comprising:
generating a composite file index for files stored in all the memory cards inserted in the corresponding memory card slots.

11. The method of claim 9, further comprising:
enabling a switching mode of the image forming apparatus to be set as an automatic switching mode to automatically switch to a memory card whenever a file contained in the memory card is indicated or a passive switching mode to enable a single memory card to be selected and to enable files contained in the single selected memory card to be accessed.

12. The method of claim 9, further comprising:
enabling a switching mode to be set as one of a first mode in which a user can cycle through all files contained in all the memory cards inserted in the corresponding memory card slots and a second mode in which the user can cycle through all files contained in a selected memory card.

13. An apparatus to automatically switch among memory cards inserted into a plurality of memory card slots in a multifunctional device, respectively, the apparatus comprising:
a memory card history manager to manage histories of the memory cards inserted into the plurality of memory card slots;
a controller to automatically switch from a current memory card to a next memory card according to a predefined order when switching of the memory cards is appropriate; and
a memory card interface unit to enable data to be transmitted to the next memory card and read from the next memory card.

14. The apparatus of claim 13, wherein the predefined order comprises a switching order defined by one of an insertion order in which the memory cards are inserted into the plurality of memory card slots and a predetermined order that is independent of the insertion order.

15. The apparatus of claim 13, wherein the memory card interface unit creates a file allocation table to display a file order in which files are stored in the current memory card.

16. The apparatus of claim 15, wherein the controller determines that the switching of the memory cards is appropriate when a user moves an indicator on a first file or a last file in the file allocation table to point to a file in another file allocation table.

17. The apparatus of claim 13, wherein the memory card interface unit further receives data about the next memory card from the next memory card.

18. The apparatus of claim 13, wherein the controller determines whether a switching mode of the multifunctional device is set to an automatic switching mode.

19. The apparatus of claim 18, wherein when the switching mode is not set to the automatic switching mode, the controller enables a user to select a desired memory card from among the memory cards.

20. The apparatus of claim 13, further comprising a detector to determine whether the memory cards are inserted into or are removed from the plurality of memory card slots.

21. The apparatus of claim 13, wherein when the multifunctional device is turned on, the memory card history manager rearranges the predefined order according to a frequency with which the memory cards are used.

22. The apparatus of claim 13, wherein the controller controls data stored in a selected memory card to be printed.

23. A method of configuring removable disk drivers in a host device connected to a multi-memory card reader associated with a plurality of memory card slots, the method comprising:
determining whether memory cards are inserted into the plurality of memory card slots, respectively;
counting a number of memory card slots having corresponding memory cards inserted therein; and
transmitting the counted number of memory card slots having the corresponding memory cards inserted therein to the host device.

24. The method of claim 23, further comprising:
generating removable disk drivers to correspond to the counted memory card slots.

25. The method of claim 23, further comprising:
recounting the number of memory cards having the corresponding memory cards inserted therein when any of the memory cards are removed from the corresponding memory card slots or new memory cards are inserted into the corresponding memory card slots.

26. The method of claim 23, wherein the counting of the plurality of memory card slots comprises:
generating a logical unit number equivalent to the counted number of memory card slots having the corresponding memory cards inserted therein; and
transmitting the logical unit number to the host device.

27. The method of claim 23, further comprising:
generating removable disk drivers to correspond to the counted memory card slots; and
displaying the generated removable disk drivers such that a user can view the displayed removable disk drivers.

28. A method of creating removable disc drivers for one or more memory cards inserted in one or more corresponding memory card slots among a plurality of memory card slots, the method comprising:
receiving memory card information about the one or more memory cards that are inserted in the one or more corresponding memory card slots among the plurality of memory card slots from a multi-memory card reader associated with an image forming apparatus; and
creating one or more removable disc drivers to correspond with the one or more memory cards that are inserted in the one or more corresponding memory card slots according to the memory card information received from the multi-memory card reader associated with the image forming apparatus.

29. The method of claim 28, wherein the memory card information includes a logical unit number (LUN) that represents the one or more memory cards that are inserted in the one or more corresponding memory card slots.

30. A method of creating removable disc drivers for one or more memory cards inserted in one or more corresponding memory card slots among a plurality of memory card slots, the method comprising:
determining memory card information about the one or more memory cards that are inserted in the one or more corresponding memory card slots among the plurality of memory card slots;
transmitting the memory card information to a host device; and
updating the memory card information whenever a new memory card is inserted into a corresponding memory card slot among the plurality of memory card slots or any of the one or more memory cards that are inserted in the corresponding one or more memory card slots among the plurality of memory card slots is removed therefrom.

31. A printer in communication with a host device, the printer comprising:
a multi-memory card reader having a plurality of memory card slots;
a determining unit to determine whether memory cards are inserted into the plurality of memory card slots, respectively;
a counting unit to count a number of memory card slots having corresponding memory cards inserted therein; and
a transmitting unit to transmit the counted number of memory card slots to the host device.

32. The printer of claim 31, wherein the host device generates removable disk drivers to correspond to the counted memory card slots, respectively.

33. The printer of claim 31, wherein the counting unit recounts the number of memory card slots having the corresponding memory cards inserted therein when any new memory cards are inserted into the memory card slots or any of the memory cards are removed from the corresponding memory card slots.

34. The printer of claim 31, wherein the counting unit generates a logical unit number equivalent to the counted number of memory card slots, and the transmitting unit transmits the logical unit number to the host device.

35. The printer of claim 31, wherein the host device generates removable disk drivers to correspond to the counted memory card slots, respectively, and displays the generated removable disk drivers such that a user can view the generated removable disk drivers.

36. A image forming system including a host device, the system comprising:
an image forming apparatus having a plurality of memory card slots to receive a plurality of corresponding memory cards;
a memory card managing unit to determine a status of the plurality of memory card slots and to transmit the status of the plurality of memory card slots to the host device.

37. The system of claim 36, wherein the status of the plurality of memory cards includes whether each of the plurality of memory card slots currently have the corresponding memory cards inserted therein.

38. The system of claim 37, further comprising:
an automatic memory card switcher to automatically switch between a current memory card and a next memory card when a file indicator is moved from a file in the current memory card to a file in the next memory card.

39. The system of claim 37, wherein the memory card managing unit comprises a memory card interface unit to generate a composite index of all files stored in ones of the plurality of memory cards that are inserted in the corresponding ones of the plurality of memory card slots.
